(19) United States
(12) Patent Application Publication
(10) Pub. No.: US 2025/0260082 A1
(43) Pub. Date: Aug. 14, 2025

(54) WASHING FLUID, METHOD FOR RECOVERING WASHING FLUID, AND DEVICE FOR RECOVERING WASHING FLUID

(71) Applicants: SAMSUNG SDI CO., LTD., Yongin-Si Gyeonggi-do (KR); STM CO., LTD., Ulju-gun Ulsan (KR)

(72) Inventors: Eunok Oh, Yongin-Si Gyeonggi-do (KR); Seongin Park, Yongin-Si Gyeonggi-do (KR); Kieun Park, Yongin-Si Gyeonggi-do (KR); Ji Ho Park, Hwaseong-si Gyeonggi-do (KR); Young Hwan Hwang, Yeongdo-gu Busan (KR); Jong Yo Yun, Nam-gu Ulsan (KR); Hak Man Lee, Yangsan-si Gyeongsangnam-do (KR); Wonseok Lee, Haeundae-gu Busan (KR)

(21) Appl. No.: 19/048,290

(22) Filed: Feb. 7, 2025

(30) Foreign Application Priority Data
Feb. 8, 2024 (KR) 10-2024-0019934

(51) Int. Cl. H01M 10/54; C01G 53/42; C22B 26/12; H01M 4/36; H01M 4/525; H01M 4/62; H01M 10/42

(52) U.S. Cl. CPC H01M 10/54; C01G 53/42; C22B 26/12; H01M 4/366; H01M 4/525; H01M 4/628; H01M 10/4235; C01P 2002/54

(57) ABSTRACT

The present disclosure relates to a method for recovering a washing fluid, a device for recovering the washing fluid, and a washing fluid recovered by the method. The method includes preparing a positive electrode active material including a nickel-containing lithium composite oxide, adding a first washing fluid to the positive electrode active material to form a mixture, wherein the first washing fluid includes a coating raw material, and recovering the washing fluid from the mixture, wherein the washing fluid has a lithium concentration equal to or greater than about 3500 ppm.

### CROSS-REFERENCE TO RELATED APPLICATIONS

This U.S. non-provisional patent application claims priority to and the benefit under 35 U.S.C. § 119(a)-(d) of Korean Patent Application No. 10-2024-0019934, filed on Feb. 8, 2024, the entire disclosures of which are incorporated by reference herein.

### BACKGROUND

### Field

The present disclosure relates to a method for recovering a washing fluid, a device for recovering the washing fluid, and the washing fluid recovered implementing the method.

### Description of the Related Art

Rechargeable lithium batteries are utilized as energy storage and supply sources in a broad range of applications. Such applications include portable devices, such as smartphones, tablets, wearables, laptops, digital cameras, and power tools, and various aspects of transportation, such as hybrid cars, electric vehicles, and electric boards, rechargeable lithium batteries. Nowadays, rechargeable lithium batters are used in industries such as drones, robots, and Urban Air Mobility (UAM).

Awareness of climate change and increasing interest in eco-friendliness have driven significant growth in the electric vehicle market, resulting in a sharp rise in the use of rechargeable lithium batteries. However, as essential raw materials for manufacturing rechargeable lithium batteries come from natural resources, extraction of these raw materials inevitably leads to environmental damage and pollution. Consequently, there is a pressing need for developing technology related to recycling these raw materials.

Accordingly, methods for recovering valuable metals, such as transition metal precursors and lithium precursors, from waste rechargeable lithium batteries and waste related to rechargeable lithium batteries, including waste generated from a rechargeable lithium battery manufacturing process and wastewater generated from a positive electrode active material washing process, are drawing significant attention, where recovered valuable metals may be reused for manufacturing rechargeable lithium batteries. Research and development are actively underway to develop recycling methods that are environmentally friendly, cost-conscious, and capable of recovering relatively high concentrations of valuable metals.

Various methods are in place to recover valuable metals from waste rechargeable lithium batteries or waste generated from a rechargeable lithium battery manufacturing process. However, these typical methods require the use of relatively large amounts of basic solutions during the recovery process. Considering that byproducts of basic solutions are detrimental to the environment, there is a need to develop alternatives to these basic solutions.

Also, various methods are in place to recover lithium precursors from wastewater from a positive electrode active material washing process. The wastewater from the washing of a positive electrode active material usually contains a substantial amount of lithium. However, these typical methods require a separate, independent process to recover lithium precursors from the wastewater. In addition, given that no process is capable of achieving 100% recovery, the separate, independent process would necessarily entail lithium losses. Thus, there is a need to develop an enhanced method for recovering lithium precursors.

### SUMMARY

The present disclosure provides a method for recovering a washing fluid containing lithium in a relatively high concentration and having a relatively high quality, and a device for recovering the washing fluid.

Embodiments of the present disclosure provide a method for recovering a washing fluid, including synthesizing positive electrode active material particles including a nickel-containing lithium composite oxide, injecting a first washing fluid to the positive electrode active material particles and mixing, where the first washing fluid includes a coating raw material, a precipitant, and a solvent, filtering the mixture to separate a liquid mixture, and recovering the separated liquid mixture, wherein a concentration of lithium in the recovered washing fluid is about 3500 ppm or more.

Embodiments of the present disclosure provide a device for recovering a washing fluid, including a tank part, a valve part, a line part, and a pump part, and may recover a washing fluid using the recovering method.

Embodiments of the present disclosure provide a washing fluid that may be recovered by the recovering method of the washing fluid.

Embodiments of the disclosure provide method for preparing a washing fluid includes: preparing a positive electrode active material including a nickel-containing lithium composite oxide; adding a first washing fluid to the positive electrode active material to form a mixture, wherein the first washing fluid includes a coating raw material; and recovering the washing fluid from the mixture, wherein the recovered washing fluid has a lithium concentration equal to or greater than about 3500 ppm.

In an embodiment, the nickel-containing lithium composite oxide is represented by Chemical Formula 1:

Liₐ₁Niₓ₁M¹_{y1}M²_{z1}O_{2-b1}X_{b1} [Chemical Formula 1]

where 0.9≤a1≤1.8, 0.8≤x1≤1, 0≤y1≤0.2, 0≤z1≤0.2, 0.9≤x1+y1+z1≤1.1, and 0≤b1≤0.1, M¹ and M² each independently includes one or more elements selected from the group consisting of Al, B, Ba, Ca, Ce, Co, Cr, Cu, Fe, Mg, Mn, Mo, Nb, Si, Sr, Ti, V, W, and Zr, and X includes one or more elements selected from the group consisting of F, P and S.

In an embodiment, the coating raw material includes a cobalt compound.

In an embodiment, the first washing fluid further includes a precipitant and a solvent.

In an embodiment, the precipitant includes sodium hydroxide.

In an embodiment, the solvent includes distilled water or an alkaline solution.

In an embodiment, the lithium concentration is about 3500 ppm to about 10000 ppm.

In an embodiment, an impurity concentration of the recovered washing fluid is about 20 ppm to about 30000 ppm.

In an embodiment, the recovering step includes filtering the mixture.

Embodiments of the disclosure provides a device for recovering a washing fluid, the device including a tank part, a valve part, a line part, and a pump part, wherein the device is configured to recover the washing fluid from a mixture of a positive electrode active material and a first washing fluid.

Embodiments of the disclosure provides a washing fluid having a lithium concentration of equal to or greater than about 3500 ppm.

### BRIEF DESCRIPTION OF THE FIGURES

The following drawings attached to this specification illustrate embodiments of the present disclosure, and describe aspects and features of the present disclosure together with the detailed description of the present disclosure. The present disclosure is not limited to embodiments depicted in the drawings:

FIG. 1 is a schematic view showing a rechargeable lithium battery according to embodiments of the present disclosure.

FIGS. 2 to 5 are schematic views showing a rechargeable lithium battery according to embodiments of the present disclosure. FIG. 2 shows a cylindrical battery, FIG. 3 shows cross-section of a prismatic battery, and FIGS. 4 and 5 show pouch-type batteries.

FIG. 6 is an enlarged schematic view showing a positive electrode active material layer according to embodiments of the present disclosure.

FIG. 7 is a flowchart showing a method for producing a positive electrode active material according to embodiments of the present disclosure.

FIGS. 8, 9, and 10 are each a schematic diagram showing a method for producing a positive electrode active material according to embodiments of the present disclosure.

FIG. 11 is a flowchart showing a method for recovering a washing fluid according to embodiments of the present disclosure.

FIG. 12 is a flowchart showing a method for recovering a washing fluid according to an comparative embodiment of the present disclosure.

FIG. 13 is a schematic diagram showing a device for recovering a washing fluid according to embodiments of the present disclosure.

FIG. 14 is a flowchart showing a method for extracting a lithium precursor from a washing fluid according to embodiments of the present disclosure.

FIG. 15 is a flowchart showing a method for preparing a first solution for extracting a lithium precursor according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as being consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

When an element is referred to as being on another element, the element can be directly on the other element or intervening elements may be present between therebetween. In the drawings, thicknesses of some components can be exaggerated for effectively explaining the technical contents. Like reference numerals refer to like elements throughout the specification.

The embodiments described herein can be explained with reference to cross-sectional views and/or plan views as example views of the present disclosure. In the drawing, the thicknesses of films and regions can be exaggerated for effective description of technical contents. Thus, regions presented as an example in the drawings have general properties, and shapes of the exemplified areas can be used to illustrate a specific shape of a device region. Therefore, this should not be construed as limited to the scope of the present disclosure. Although the terms such as first, second, and third are used to describe various components in various embodiments herein, the components should not be limited to these terms. These terms are used only to distinguish one component from another component. Embodiments described and exemplified herein include complementary embodiments thereof.

Terms used herein are not for limiting the present disclosure but for describing the embodiments. As used herein, the singular forms include the plural forms as well, unless the context clearly indicates otherwise. The meaning of “includes,” “including,” “comprises,” and/or “comprising,” used herein does not exclude the presence or addition of one or more other components besides a mentioned component.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

As used herein, the term “combination thereof” may refer to a mixture, a stack, a composite, a copolymer, an alloy, a blend, or a reaction product.

Unless otherwise specially defined in the description, a particle diameter may be an average particle diameter. Also, a particle diameter means an average particle diameter (D50), which refers to the diameter of particles at a cumulative volume of about 50 vol % in particle size distribution. The average particle diameter (D50) may be measured by a method widely known to those skilled in the art, for example, by a particle size analyzer, or by using a transmission electron microscope (TEM) image or a scanning electron microscope (SEM) image. Alternatively, the average particle diameter may be measured by a measurement device using dynamic light-scattering, wherein data analysis is conducted to count the number of particles for each particle size range, and an average particle diameter (D50) value may then be obtained through calculation. Also, a laser scattering method may be utilized to measure the average particle diameter. In the laser scattering method, target particles are dispersed in a dispersion medium, then, introduced into a commercial laser diffraction particle-diameter measurement instrument (e.g., MT3000 of Microtrac), and irradiated to ultrasonic waves of about 28 kHz at an output of about 60 W, and the average particle diameter (D50) based on about 50% of particle diameter distribution may be calculated in the measurement instrument.

As used herein, the “atomic fraction” used in the present disclosure may be obtained as a result of analyzing the elements on the surface of a positive electrode active material CAM using an energy dispersive spectrometer (EDX), that is, SEM-EDS. The atoms on the surface of the positive electrode active material CAM, that collide with an electron beam may emit unique specific X-rays (characteristic X-rays). By analyzing the emitted X-rays through an EDX detector, the type and content of the corresponding element may be confirmed. The content obtained may correspond to the “atomic fraction.”

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will be understood that when a component is referred to as being “linked,” “coupled,” or “connected” to another component, the elements may be directly “coupled,” “linked” or “connected” to each other, or another component may be “interposed” between the components ”.

Numerical ranges disclosed and/or recited herein include all sub-ranges of the same numerical precision subsumed within the recited ranges. For example, a range of “1.0 to 10.0” includes all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein includes all lower numerical limitations subsumed therein, and any minimum numerical limitation recited in this specification includes all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Terms used herein describe embodiments of the present disclosure and do not limit the present disclosure.

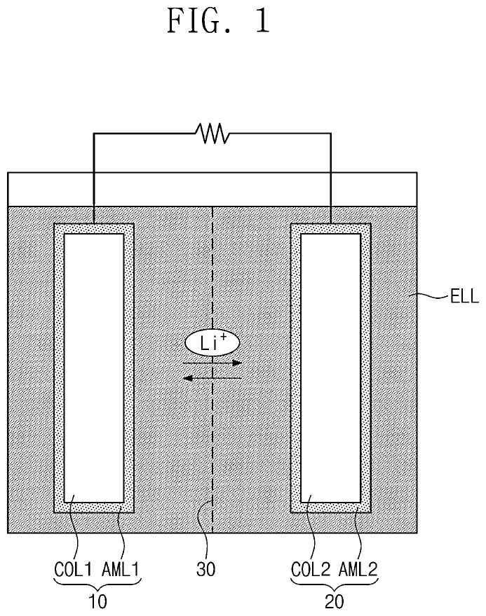

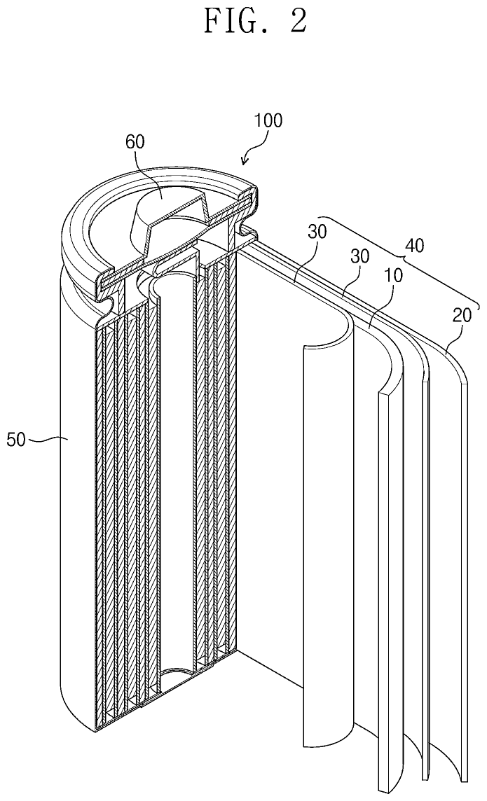

FIG. 1 is a cross-sectional schematic view of a rechargeable lithium battery (e.g., 100 of FIGS. 2 to 5) according to embodiments of the present disclosure. The rechargeable lithium battery (e.g., 100 of FIGS. 2 to 5) may include a positive electrode 10, a negative electrode 20, a separator 30, and an electrolyte solution ELL.

The positive electrode 10 and the negative electrode 20 may be spaced apart from each other via the separator 30. The separator 30 may be positioned between the positive electrode 10 and the negative electrode 20. The positive electrode 10, the negative electrode 20 and the separator 30 may be in contact with the electrolyte solution ELL. The positive electrode 10, the negative electrode 20 and the separator 30 may be immersed in the electrolyte solution ELL.

The electrolyte solution ELL may include a medium for transferring lithium ions between the positive electrode 10 and the negative electrode 20. In the electrolyte solution ELL, the lithium ions may migrate through the separator 30 toward the positive electrode 10 or the negative electrode 20.

### Positive Electrode 10

The positive electrode 10 for a rechargeable lithium battery may include a current collector COL1 and a positive electrode active material layer AML1 positioned on the current collector COL1. The positive electrode active material layer AML1 may include a positive electrode active material and may further include a binder and/or a conductive material.

In an embodiment, the positive electrode 10 may further include an additive that can be configured to serve as a sacrificial positive electrode.

The positive electrode active material in the positive electrode active material layer AML1 may amount from about 90 wt % to about 99.5 wt % based on 100 wt % of the positive electrode active material layer AML1. Each of the binder and the conductive material may amount from about 0.5 wt % to about 5 wt % based on 100 wt % of the positive electrode active material layer AML1.

The binder is configured to adhere particles of the positive electrode active material to one another and also to adhere the positive electrode active material to the current collector COL1. Non-limiting examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon.

The conductive material is configured to ensure conductivity (e.g., electrical conductivity) to the electrode. Any material that does not contribute to chemical change (e.g., does not contributed to an undesirable chemical change in the rechargeable lithium battery) while being capable of conducting electrons can be used in the battery. Non-limiting examples of the conductive material may include a carbon-based material such as natural graphite, artificial graphite, carbon black, acetylene black, Ketjen black, carbon fiber, carbon nano-fiber, and carbon nano-tube, a metal-based material with a metal powder or metal fiber type, containing copper, nickel, aluminum, silver or the like, a conductive polymer such as a polyphenylene derivative, or a mixture thereof.

Al may be used as the current collector COL1, but an embodiment of the inventive concept is not limited thereto.

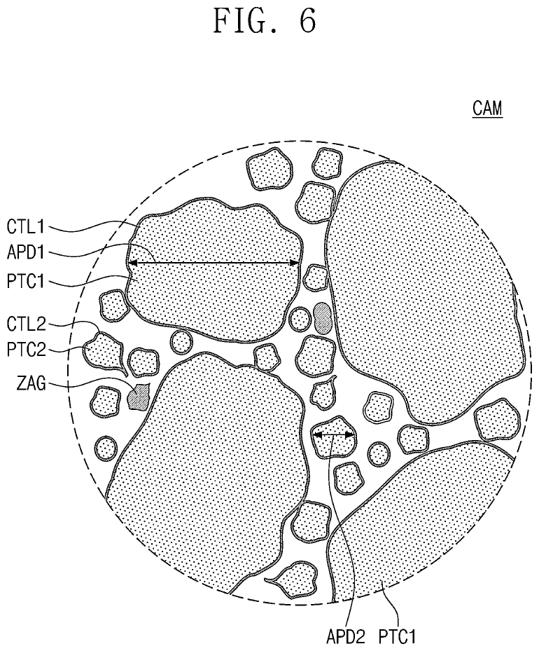

The positive electrode active material is described in detail with reference to FIG. 6.

### Negative Electrode 20

The negative electrode 20 for a rechargeable lithium battery may include a current collector COL2, and a negative electrode active material layer AML2 positioned on the current collector COL2. The negative electrode active material layer AML2 may include a negative electrode active material and may further include a binder and/or a conductive material.

In an embodiment, the negative electrode active material layer AML2 may include about 90 wt % to about 99 wt % of the negative electrode active material, about 0.5 wt % to about 5 wt % of the binder, and about 0 wt % to about 5 wt % of the conductive material.

The binder is configured to adhere particles of the negative electrode active material to one another and also to adhere the negative electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

If an aqueous binder is used as the negative electrode binder, a cellulose-based compound capable of enhancing viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material where the polymer material can be fibrous. As a non-limiting example, the dry binder may include polytetrafluoroethylene, polyvinylidene fluoride, a polyvinylidene fluoride-hexafluoropropylene copolymer, polyethylene oxide, or a combination thereof.

The conductive material is configured to ensure conductivity (e.g., electrical conductivity) to an electrode. Any material that does not contribute to chemical change (e.g., does not contribute to an undesirable chemical change in the rechargeable lithium battery) and while being capable of conducting electrons can be used in the battery. Non-limiting examples of the conductive material may include a carbon-based material such as natural graphite, artificial graphite, carbon black, acetylene black, Ketjen black, a carbon fiber, a carbon nanofiber, and carbon nanotube; a metal-based material including copper, nickel, aluminum, silver or the like, in a form of a metal powder or a metal fiber; a conductive polymer such as a polyphenylene derivative; or a mixture thereof.

The current collector COL2 may use a copper foil, a nickel foil, a stainless steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that is capable of reversibly intercalating/deintercalating lithium ions, a lithium metal, a lithium metal alloy, a material capable of doping into and de-doping from lithium, or a transition metal oxide.

The material capable of reversibly intercalating/deintercalating lithium ions may include a carbon-based negative electrode active material, such as, crystalline carbon, amorphous carbon or a combination thereof. The crystalline carbon may include graphite such as non-shaped, sheet-shaped, flake-shaped, sphere-shaped, or fiber-shaped natural graphite or artificial graphite. The amorphous carbon may include a soft carbon, a hard carbon, a mesophase pitch carbide product, calcined coke, and the like.

The lithium metal alloy may include an alloy of lithium with a metal selected from Na, K, Rb, Cs, Fr, Be, Mg, Ca, Sr, Si, Sb, Pb, In, Zn, Ba, Ra, Ge, Al, and Sn.

The material capable of doping into and de-doping from lithium may include a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline earth metal, a Group 13 element, a Group 14 element (except for Si), a Group 15 element, a Group 16 element, a transition metal, a rare earth element, and a combination thereof), or a combination thereof. The Sn-based negative electrode active material may be Sn, SnO₂, a Sn-based alloy, or a combination thereof.

The silicon-carbon composite may include a composite of silicon and amorphous carbon. In an embodiment, the silicon-carbon composite may exist in a silicon particle form or a silicon particle coated with amorphous carbon on the surface thereof. In an embodiment, the silicon-carbon composite may include a secondary particle (core), in which primary silicon particles are assembled, and an amorphous carbon coating layer (shell) may be positioned on the surface of the secondary particle. The amorphous carbon may also be positioned between the primary silicon particles, and, in an embodiment, the primary silicon particles may be coated with the amorphous carbon. The secondary particle may be dispersed in an amorphous carbon matrix.

The silicon-carbon composite may further include crystalline carbon. In an embodiment, the silicon-carbon composite may include a core including crystalline carbon and silicon particles and an amorphous carbon coating layer on the surface of the core.

The Si-based negative electrode active material or the Sn-based negative electrode active material may be used in combination with a carbon-based negative electrode active material.

### Separator 30

Depending on the type of the rechargeable lithium battery, the separator 30 may be present between the positive electrode 10 and the negative electrode 20. The separator 30 may include polyethylene, polypropylene, polyvinylidene fluoride, or a multilayer of two or more thereof, and may also include a mixed multilayer such as a polyethylene/polypropylene two-layer separator, a polyethylene/polypropylene/polyethylene three-layer separator, a polypropylene/polyethylene/polypropylene three-layer separator or the like.

The separator 30 may include a porous substrate and a coating layer including an organic material, an inorganic material, or a combination thereof, on one or both surfaces of the porous substrate.

The porous substrate may include a polymer film including polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but an embodiment of the present disclosure is not limited thereto.

The organic material and the inorganic material may be mixed to form a single one coating layer, or may separately exist in a stacked form of a coating layer including an organic material and a coating layer including an inorganic material.

### Electrolyte Solution ELL

The electrolyte solution ELL for a rechargeable lithium battery may include a non-aqueous organic solvent and a lithium salt.

The non-aqueous organic solvent is configured to serve as a medium for transmitting ions taking part in the electrochemical reaction of a battery.

The non-aqueous organic solvent may include a carbonate-based, ester-based, ether-based, ketone-based, or alcohol-based solvent, an aprotic solvent, or a combination thereof.

The carbonate-based solvent may include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), or the like.

The ester-based solvent may include methyl acetate, ethyl acetate, n-propyl acetate, dimethyl acetate, methyl propionate, ethyl propionate, decanolide, mevalonolactone, valerolactone, caprolactone, or the like.

The ether-based solvent may include dibutyl ether, tetraglyme, diglyme, dimethoxyethane, 2-methyltetrahydrofuran, 2,5-dimethyltetrahydrofuran, tetrahydrofuran, or the like.

The ketone-based solvent may include cyclohexanone, or the like.

The alcohol-based solvent may include ethyl alcohol, isopropyl alcohol, or the like, and the aprotic solvent may include nitriles such as R-CN (wherein R is a C2 to C20 linear, branched, or cyclic hydrocarbon group, and may include a double bond, an aromatic ring, or an ether bond); amides such as dimethylformamide; dioxolanes such as 1,3-dioxolane, and 1,4-dioxolane; or sulfolanes, or the like.

The non-aqueous organic solvents may be used alone or in combination of two or more thereof.

In addition, when using a carbonate-based solvent, a cyclic carbonate and a chain carbonate may be combined and used, and the cyclic carbonate and the chain carbonate may be combined in a volume ratio of about 1:1 to about 1:9.

The lithium salt dissolved in the organic solvent is configured to supply lithium ions in a battery, enable a basic operation of a rechargeable lithium battery, and improve the transportation of the lithium ions between the positive electrode and the negative electrode. Non-limiting examples of the lithium salt may include LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluoro(oxalato) phosphate (LiBOB), or lithium bis(oxalato) borate (LiBOB).

### Rechargeable Lithium Battery 100

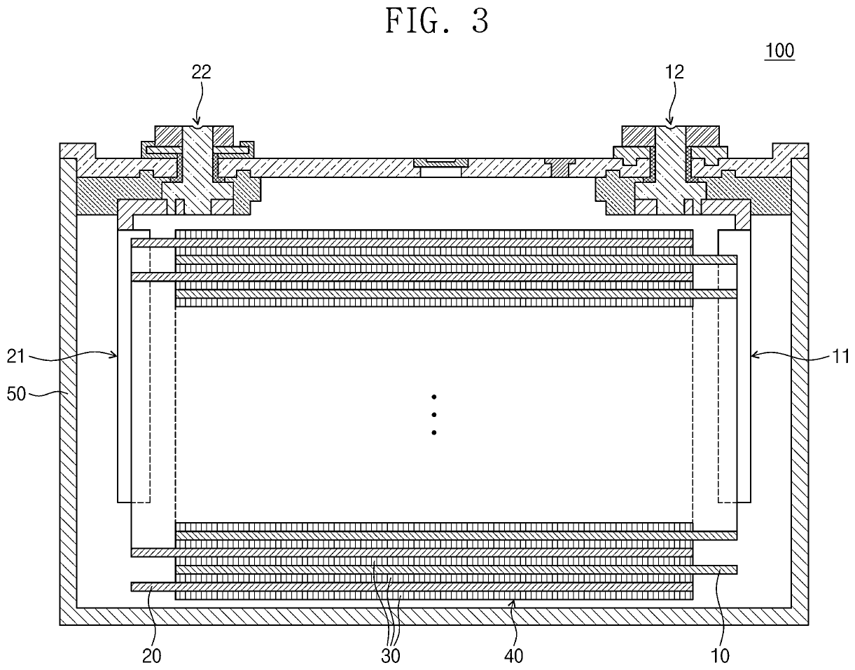

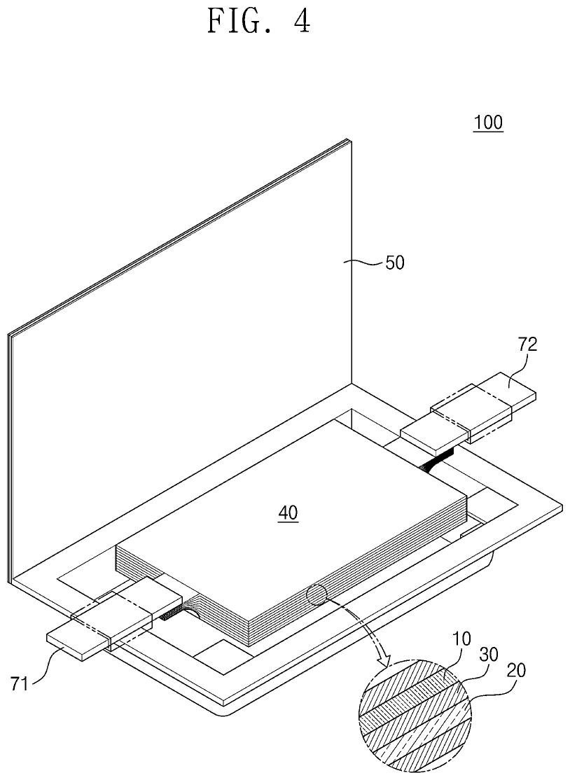

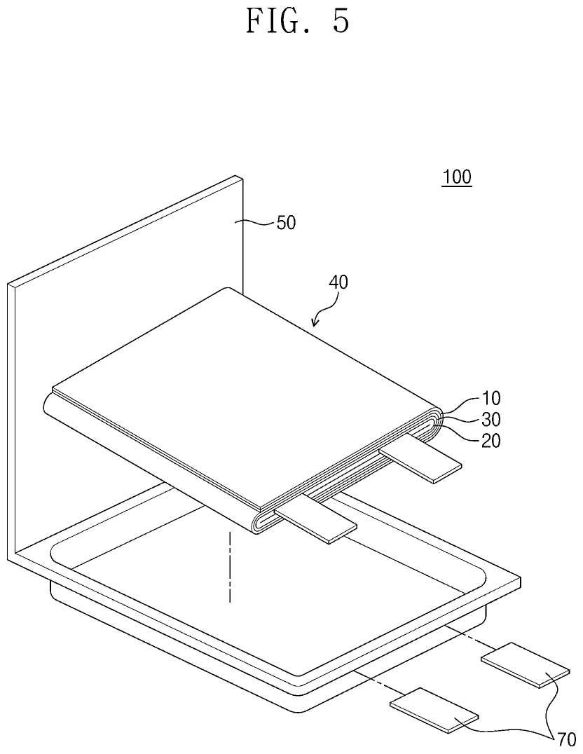

The rechargeable lithium battery 100 may be classified into cylindrical, prismatic, pouch, or coin-type batteries, depending on its shape. FIGS. 2 to 5 are schematic views showing rechargeable lithium batteries according to embodiments of the present disclosure. FIG. 2 shows a cylindrical battery, FIG. 3 shows a prismatic battery, and FIGS. 4 and 5 show pouch-type batteries.

The rechargeable lithium battery 100 may include an electrode assembly 40 including a separator 30 positioned between a positive electrode 10 and a negative electrode 20, and a case 50 encompassing the electrode assembly 40. The positive electrode 10, the negative electrode 20, and the separator 30 may be immersed in an electrolyte solution (not shown). The rechargeable lithium battery 100 may include a sealing member 60 sealing the case 50, as shown in FIG. 2. In FIG. 3, the rechargeable lithium battery 100 may include a positive electrode lead tab 11, a positive terminal 12, a negative electrode lead tab 21, and a negative terminal 22. As shown in FIGS. 4 and 5, the rechargeable lithium battery 100 may include an electrode tab 70, that is, a positive electrode tab 71 and a negative electrode tab 72, configured to serve as an electrical path for inducing the current formed in the electrode assembly 40 to the exterior environment.

The rechargeable lithium battery 100 may be used in automobiles, mobile phones, and/or various types of electric devices, but embodiments of the present disclosure is not limited thereto.

### Positive Electrode Active Material

FIG. 6 is a schematic view showing a positive electrode active material according to embodiments of the present disclosure. A positive electrode active material CAM can be in a powder form before being used in a positive electrode active material layer AML1 described with reference to FIG. 1.

In an embodiment, the positive electrode active material CAM may include a plurality of first particles PTC1, a plurality of second particles PTC2, and a plurality of aggregates ZAG.

The first particles PTC1 may have a first average particle diameter APD1, and the second particles PTC2 may have a second average particle diameter APD2. The second average particle diameter APD2 may be smaller than the first average particle diameter APD1. In an embodiment, the first average particle diameter APD1 may be about 5 μm to about 25 μm. In an embodiment, the first average particle diameter APD1 may be about 7 μm to about 25 μm, about 10 μm to about 25 μm, about 15 μm to about 25 μm, or about 10 μm to about 20 μm. In an embodiment, the second average particle diameter APD2 may be about 0.1 μm to about 10 μm. In an embodiment, the second average particle diameter APD2 may be about 0.1 μm to about 7 μm, about 0.5 μm to about 6 μm, or about 1 μm to about 5 μm. As used herein, the “average particle diameter”, i.e. D50, used in the present disclosure may be obtained by randomly selecting about 30 secondary particle form active materials from an electron microscope photograph of a positive electrode active material, measuring the particle diameter, and taking the diameter (D50) of the particles having a cumulative volume of 50% by volume from particle size distribution as the average particle diameter. In the present disclosure, the first particle PTC1 may be named as a large particle, and the second particle PTC2 may be named as a small particle.

The first and second particles PTC1 and PTC2 may have a granular or spherical shape. In an embodiment, the first particle PTC1 may have a secondary particle form in which primary particles are aggregated. In an embodiment, the second particle PTC2 may exist in a single particle form. The single particle form may include a primary particle form, or a secondary particle form in which several primary particles are aggregated. The single particle form may include one crystal grain or several crystal grains. The crystal grain may be the smallest unit in which a lithium composite oxide has one crystal direction. In an embodiment, the second particle PTC2 may include one primary particle and/or one single particle in which multiple primary particles are combined into one.

The positive electrode active material CAM according to embodiments of the present disclosure may have a bimodal form including large particles (e.g., PTC1) and small particles (e.g., PTC2), having different average particle diameters. The integration density of the positive electrode active material CAM may be improved by the small particles filling the gaps between the large particles. In an embodiment, the positive electrode active material CAM may have a relatively high energy density per unit volume.

In an embodiment, the first particles PTC1 and the second particles PTC2 in the positive electrode active material CAM may have a weight ratio of about 95:5 to about 50:50. In an embodiment, the first particles PTC1 and the second particles PTC2 in the positive electrode active material CAM may have a weight ratio of about 5:95 to about 50:50. In an embodiment, the weight of the first particles PTC1 in the positive electrode active material CAM may be greater than the weight of the second particles PTC2.

The first particle PTC1 may include a first lithium composite oxide, and the second particle PTC2 may include a second lithium composite oxide. Each of the first and second lithium composite oxides may include nickel (Ni). In an embodiment, each of the first and second lithium composite oxides may further include at least one metal selected from the group consisting of cobalt (Co), manganese (Mn) and aluminum (Al).

In an embodiment, the first lithium composite oxide may be represented by Chemical Formula 1.

Liₐ₁Niₓ₁M¹_{y1}M²_{z1}O_{2-b1}X_{b1} [Chemical Formula 1]

where 0.9≤a1≤1.8, 0.8≤x1≤1, 0≤y1≤0.2, 0≤z1≤0.2, 0.9≤x1+y1+z1≤1.1, and 0≤b1≤0.1, M¹ and M² are each independently one or more elements selected from Al, B, Ba, Ca, Ce, Co, Cr, Cu, Fe, Mg, Mn, Mo, Nb, Si, Sr, Ti, V, W, and Zr, and X is one or more elements selected from F, P and S.

In Chemical Formula 1, 0.85≤x1≤1, 0≤y1≤0.15, and 0≤z1≤0.15, or 0.9≤x1≤1, 0≤y1≤0.1, and 0≤z1≤0.1.

The second lithium composite oxide may be represented by Chemical Formula 2.

Liₐ₂Niₓ₂M³_{y2}M⁴_{z2}O_{2-b2}X_{b2} [Chemical Formula 2]

where 0.9≤a2≤1.8, 0.8≤x2≤1, 0≤y2≤0.2, 0≤z2≤0.2, 0.9≤x2+y2+z2≤1.1, and 0≤b2≤0.1, M³ and M⁴ are each independently one or more elements selected from Al, B, Ba, Ca, Ce, Co, Cr, Cu, Fe, Mg, Mn, Mo, Nb, Si, Sr, Ti, V, W, and Zr, and X is one or more elements selected from F, P and S.

In Chemical Formula 2, 0.85≤x2≤1, 0≤y2≤0.15, and 0≤z2≤0.15, or 0.9≤x2≤1, 0≤y2≤0.1, and 0≤z2≤0.1.

M¹ and M² of the first lithium composite oxide and the ratio of the elements constituting M¹ and M² of the first lithium composite oxide may be different from M³ and M⁴ of the second lithium composite oxide and the ratio of the elements constituting M³ and M⁴ of the second lithium composite oxide. In an embodiment, M¹ and M² of the first lithium composite oxide may include Co and Al, and M³ and M⁴ of the second lithium composite oxide may include Co and Mn. In an embodiment, M¹ and M², and M³ and M⁴ may each include Co, Al, and Mn.

In an embodiment, x1, which is a molar ratio of Ni in Chemical Formula 1, may be equal to or greater than about 0.8. In an embodiment, x1 may be about equal to or greater than 0.88. If the first lithium composite oxide has a high nickel content composition (x1>0.8), the calcining of the first lithium composite oxide may be performed at a relatively low temperature. Accordingly, in the production process of the positive electrode active material for a rechargeable lithium battery, the first particles PTC1 may be synthesized at a relatively low temperature. Ni in the first lithium composite oxide may affect the output and capacity of a rechargeable lithium battery. The present disclosure may provide a high output rechargeable lithium battery by using the first lithium composite oxide having a high nickel content composition. The molar ratio of Ni in Chemical Formula 2, x2, may also be equal to or greater than 0.8. In an embodiment, x2 may be equal to or greater than 0.88. In an embodiment, x2 may be different from x1.

As the content of Ni in the first and second lithium composite oxides increases, the stability of the positive electrode or the rechargeable battery may deteriorate. In an embodiment, the first and second lithium composite oxides may further include Co, thereby effectively suppressing the collapse of a structure due to repeated charge and discharge, thereby improving life characteristics at room temperature and high temperature and improving the stability and capacity retention characteristics of the rechargeable battery.

In an embodiment, the first particle PTC1 may include a first coating layer CTL1 provided on the surface of the first particle PTC1. The second particle PTC2 may include a second coating layer CTL2 provided on the surface of the second particle PTC2. Each of the first coating layer CTL1 and the second coating layer CTL2 may include cobalt (Co). Each of the first coating layer CTL1 and the second coating layer CTL2 may be derived from a coating agent. Via the first coating layer CTL1, Co may be detected in the first particle PTC1 as a result of the SEM-EDS analysis. Via the second coating layer CTL2, Co may be detected in the second particle PTC2 as a result of the SEM-EDS analysis.

In an embodiment, each of the first coating layer CTL1 and the second coating layer CTL2 may include a cobalt (Co)-containing compound. The cobalt-containing compound may be, for example, cobalt oxide, cobalt hydroxide, cobalt carbonate, a composite thereof, or a mixture thereof. In an embodiment, the cobalt-containing compound may further include other metal or non-metal elements in addition to cobalt. In an embodiment, the cobalt-containing compound may further include lithium, manganese, and/or nickel. In an embodiment, the cobalt-containing compound may be lithium cobalt oxide or the like.

The content of cobalt in the first coating layer CTL1 with respect to the total amount of nickel and cobalt may be about 55 at % to about 70 at %, in an embodiment, about 55 at % to about 68 at %, about 55 at % to about 65 at %, about 55 at % to about 63 at %, about 57 at % to about 70 at %, about 59 at % to about 70 at %, about 60 at % to about 70 at %, about 60 at % to about 65 at %, or about 61 at % to about 63 at %. Under these conditions, coating unevenness between particles may be resolved, and a uniform coating may be formed on the surface of the first particle PTC1, so that gas generation may be suppressed and initial charge/discharge efficiency and long-term life characteristics may be improved.

The content of cobalt in the second coating layer CTL2 with respect to

the total amount of nickel and cobalt may be about 39 at % to about 45 at %, for example, about 39 at % to about 44 at %, about 39 at % to about 43 at %, about 39 at % to about 42 at %, about 40 at % to about 45 at %, or about 41 at % to about 45 at %. Under these conditions, coating unevenness between the particles may be resolved, excessive coating on the second particle PTC2 may be suppressed, and uniform coating may be induced, so that the resistance may be reduced and the initial charge/discharge efficiency and long-term life characteristics may be improved.

The first coating layer CTL1 may include a layer that uniformly or non- uniformly covers the surface of the first particle PTC1. If the first coating layer CTL1 covers the surface of the first particle PTC1 in a non-uniform manner, the first coating layer CTL1 may have an island shape. However, the first coating layer CTL1 may not be confirmed by an image using an electron microscope. The first coating layer CTL1 may be confirmed by the presence of cobalt (Co) in the first particle PTC1 using SEM-EDS. The second coating layer CTL2 may also be substantially the same as described in the first coating layer CTL1.

The shape, structure, and composition of the particles constituting the positive electrode active material CAM may be confirmed through time-of-flight secondary ion mass spectrometry (TOF-SIMS) for the positive electrode active material CAM according to embodiments of the present disclosure.

As used herein, TOF-SIMS equipment refers to SIMS equipment equipped with a mass spectrometer, TOF. Specifically, SIMS equipment may be capable of obtaining the chemical composition and surface structure of a material by analyzing the ions (positive or negative ions) emitted during the collision of the primary ions with the surface of an analyte. According to TOF-SIMS analysis, Co may not be detected inside each of the first and second particles PTC1 and PTC2. That is, the presence of Co in the particles PTC1 and PTC2 may be indirectly confirmed through the form of the coating layers CTL1 and CTL2 on the surfaces thereof.

In an embodiment, the first particles PTC1 may have a secondary particle form. In this case, micro-cracks may be formed inside the secondary particles during charging and discharging of a battery, and a side reaction between the electrolyte (e.g., ELL of FIG. 1) and the positive electrode active material CAM may happen, generating gas inside the battery. Accordingly, the stability and lifespan of a rechargeable battery may be reduced.

In an embodiment, the second particles PTC2 may exist in a single particle form. The second particles PTC2 may have higher durability and may be denser than the first particles PTC1. Therefore, the formation of micro-cracks inside the second particles PTC2 may be prevented. As a result, the stability and capacity retention characteristics of the rechargeable battery may be improved.

The aggregate ZAG may be provided in the space between the first and second particles PTC1 and PTC2. The aggregate ZAG may be derived from a coating agent described later. The agglomerate ZAG may contain zirconium (Zr). In an embodiment, the agglomerate ZAG may contain zirconia. In an embodiment, the agglomerate ZAG may be a lump formed by agglomeration of a portion of the coating agent that is not coated on the surfaces of the first and second particles PTC1 and PTC2.

In an embodiment, the positive electrode active material CAM may include a plurality of first particles PTC1. In an embodiment, the positive electrode active material CAM may include a plurality of aggregates ZAG in addition to the plurality of first particles PTC1.

In an embodiment, the positive electrode active material CAM may include a plurality of second particles PTC2. In an embodiment, the positive electrode active material CAM may include a plurality of aggregates ZAG in addition to the plurality of second particles PTC2.

### Method for Producing Positive Electrode Active Material

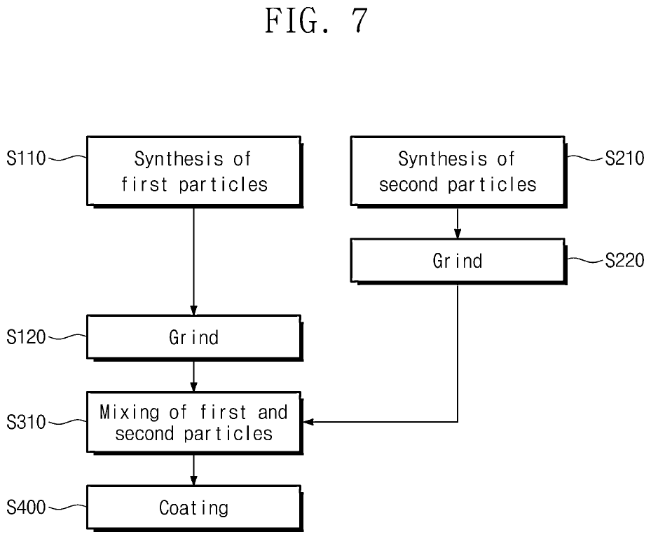

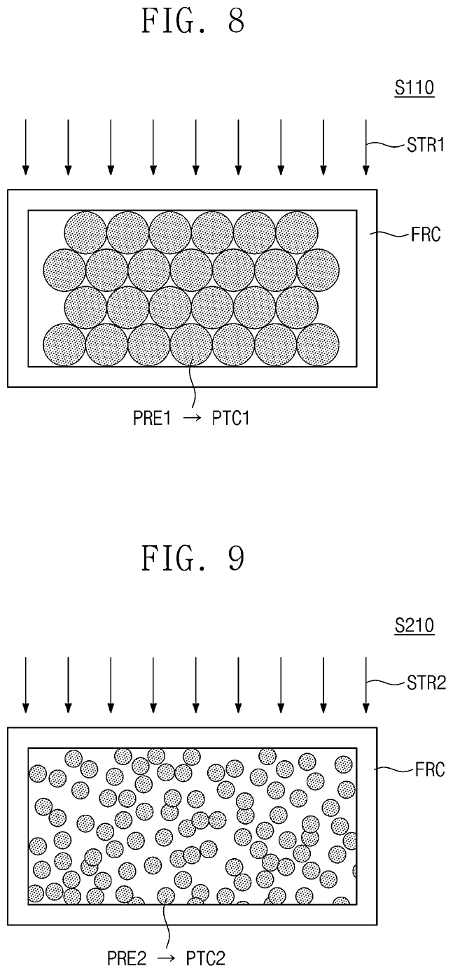

FIG. 7 is a flowchart showing a method for producing a positive electrode active material according to embodiments of the present disclosure. FIGS. 8 to 10 are each a schematic diagram showing a method for producing a positive electrode active material of FIG. 7 according to embodiments of the present disclosure.

Referring to FIGS. 7 and 8, first particles PTC1 may be synthesized (S110). First, a first precursor PRE1 may be prepared. The first precursor PRE1 may include Ni, M¹, and M² of Chemical Formula 1. M¹ and M² may each independently be at least one element selected from Al, B, Ba, Ca, Ce, Co, Cr, Cu, Fe, Mg, Mn, Mo, Nb, Si, Sr, Ti, V, W, and Zr.

In an embodiment, the first precursor PRE1 may be obtained via a co-precipitation method. In an embodiment, the co-precipitation method may include dissolving a transition metal raw material in a solvent such as distilled water, and continuously introducing a transition metal salt solution into a reactor together with a chelating agent and an alkaline aqueous solution to arise precipitation. After collecting the precipitate in the form of a slurry, the slurry solution may be filtered and dried to obtain the first precursor PRE1, which can include a metal composite oxide.

The transition metal raw material may include a metal salt of at least one element selected from Ni, Al, B, Ba, Ca, Ce, Co, Cr, Cu, Fe, Mg, Mn, Mo, Nb, Si, Sr, Ti, V, W, and Zr. The metal salt may include a sulfate, a nitrate, an acetate, a halide, a hydroxide, and the like, and is not particularly limited as long as it may be dissolved in a solvent. The transition metal raw material may include a nickel salt, a cobalt salt, and an aluminum salt. The transition metal raw material may be mixed by adjusting the molar ratio so that the positive electrode active material may have high capacity characteristics. In an embodiment, x1 in Chemical Formula 1 may be determined by the molar ratio.

The first precursor PRE1 may be mixed with a lithium raw material at a certain ratio to form a mixture. In an embodiment, the first precursor PRE1 and the lithium raw material may be mixed at a molar ratio of about 1:1. The lithium raw material is not particularly limited as long as it is a material commonly used in the production of positive electrode active materials. In an embodiment, the lithium raw material may include a lithium salt such as lithium carbonate, lithium nitrate, lithium hydroxide, and lithium sulfate.

The mixture may be put into a furnace FRC and a first calcining process STR1 may be performed at a first temperature. The first temperature may be about 700° C. to about 1,000° C. In an embodiment, the first temperature may be about 900° C. to about 1,000° C. The first calcining process STR1 may be performed in an oxidizing atmosphere such as air and oxygen. The heat treatment time of the first calcining process STR1 may be about 10 to about 30 hours. In an embodiment, a preliminary calcining may be additionally performed at about 150° C. to about 800° C. before the first calcining process STR1.

Via the first calcining process STR1, the first particles PTC1 may be formed from the mixture including the first precursor PRE1 and the lithium raw material. A grinding process may be performed on the synthesized first particles PTC1 (S120). The ground first particles PTC1 may have a first average particle diameter APD1 described with reference to FIG. 6.

Referring to FIGS. 7 and 9, the second particles PTC2 may be synthesized (S210). First, a second precursor PRE2 may be prepared. The second precursor PRE2 may include Ni, M³, and M⁴ of Chemical Formula 2. M³ and M⁴ may each independently include at least one element selected from Al, B, Ba, Ca, Ce, Co, Cr, Cu, Fe, Mg, Mn, Mo, Nb, Si, Sr, Ti, V, W, and Zr.

In an embodiment, the second precursor PRE2 may be obtained by a method substantially the same as or similar to that of the first precursor PRE1. The average particle diameter of the second precursor PRE2 may be formed to be smaller than the average particle diameter of the first precursor PRE1.

The second precursor PRE2 may be mixed with a lithium raw material at a certain ratio to form a mixture. The mixture may be put into a furnace FRC and a second calcining process STR2 may be performed at a second temperature. The second temperature may be about 700° C. to about 1,000° C. In an embodiment, the second temperature may be about 700° C. to about 800° C. In an embodiment, the second temperature may be lower than the first temperature. The description of the second calcining process STR2 may be the same as or similar to the first calcining process STR1.

Via the second calcining process STR2, the second particles PTC2 may be formed from the mixture including the second precursor PRE2 and the lithium raw material. A grinding process may be performed on the synthesized second particles PTC2 (S220). The ground second particles PTC2 may have a second average particle diameter APD2 described with reference to FIG. 6.

Referring to FIG. 7, the first particles PTC1 and the second particles PTC2 may be combined with each other (S310). In an embodiment, the first particles PTC1 and the second particles PTC2 may be combined at a weight ratio of about 95:5 to about 50:50. In an embodiment, the first particles PTC1 and the second particles PTC2 may be combined at a weight ratio of about 5:95 to about 50:50. By combining the first particles PTC1 and the second particles PTC2, having different average particle diameters, a bimodal type positive electrode active material may be prepared. The first and second particles PTC1 and PTC2 may be further washed and dried.

In an embodiment, the mixing step (S310) of the first particles PTC1 and the second particles PTC2 may be omitted. That is, the first particles PTC1 and the second particles PTC2 may be independently subjected to a coating process (S400). As a result, a positive electrode active material CAM including a plurality of first particles PTC1 may be produced, or a positive electrode active material CAM including a plurality of second particles PTC2 may be produced.

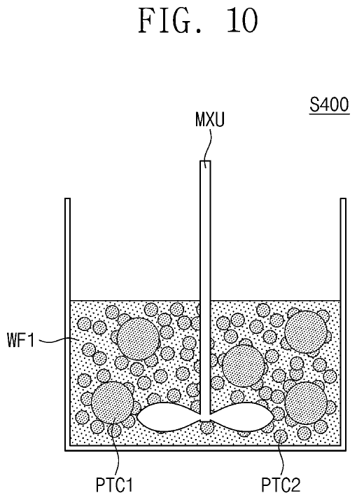

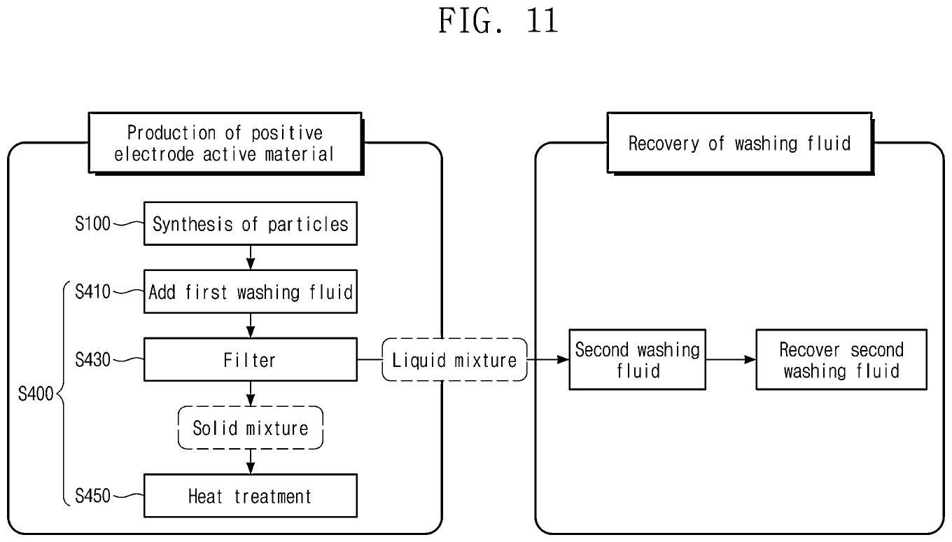

Referring to FIGS. 7 and 10, a coating process may be performed on the first and second particles PTC1 and PTC2 (S400). The coating process may include coating cobalt (Co) on the surfaces of the first and second particles PTC1 and PTC2. In an embodiment, the first and second particles PTC1 and PTC2, and a first washing fluid WF1 may be combined. The first washing fluid WF1 may include a coating raw material, a precipitant (or a pH adjuster), a solvent, or the like. The coating raw material may be a cobalt compound. In an embodiment, the cobalt compound may include cobalt sulfate, but is not particularly limited thereto. The precipitant (or pH adjuster) may include sodium hydroxide (NaOH) or the like. The solvent may include distilled water, an alkaline solution, or the like.

The first and second particles PTC1 and PTC2 and the coating raw material may be uniformly mixed through a stirrer MXU. Then, the first and second particles PTC1 and PTC2 may be filtered and dried, then surface treatment may be performed on the first and second particles PTC1 and PTC2. The surface treatment may be performed by putting the mixture into a furnace FRC and performing a third calcining process at a third temperature. In an embodiment, the third temperature may be about 500° C. to about 800° C. In an embodiment, the third temperature may be about 700° C. to about 800° C. The third calcining process may be performed in an oxidizing atmosphere such as air and oxygen. The heat treatment time of the third calcining process may be about 10 to about 30 hours. As a result, the positive electrode active material CAM described with reference to FIG. 6 may be produced.

### Washing Fluid and Recovering Method Thereof

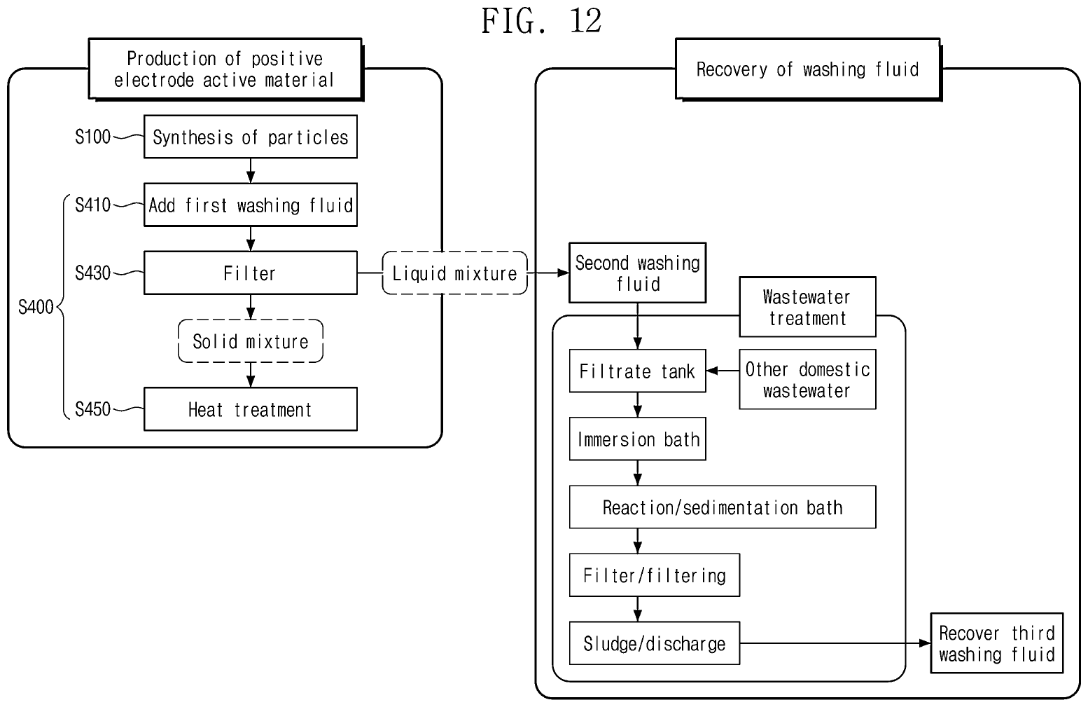

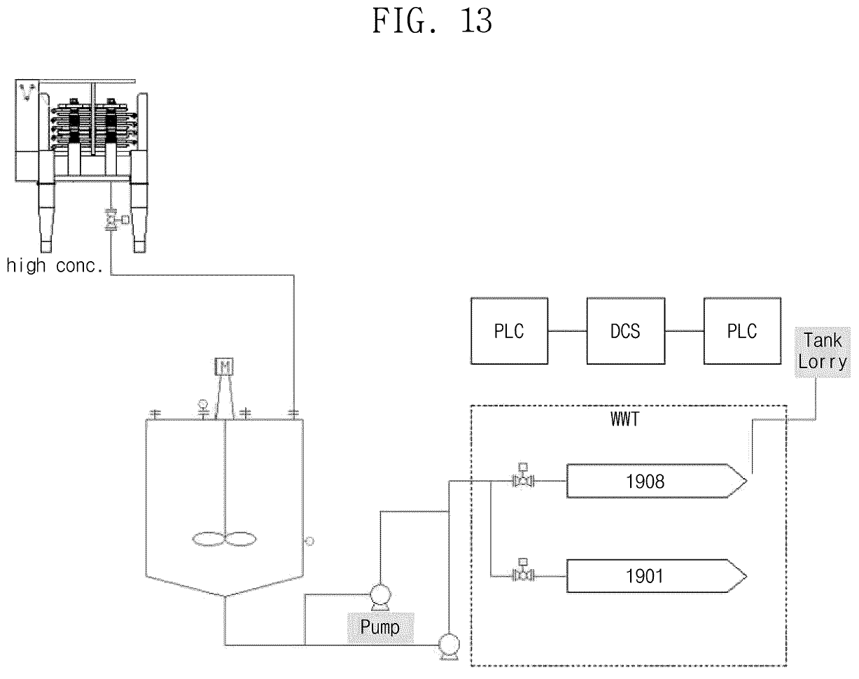

FIG. 11 is a flowchart showing a washing fluid and a recovering method thereof according to embodiments of the present disclosure. FIG. 12 is a flowchart showing a washing fluid and a recovering method thereof according to a comparative embodiment of the present disclosure.

Referring to FIG. 11, the washing fluid according to embodiments of the present disclosure may be recovered in the producing process of a positive electrode active material including a lithium composite oxide having a high nickel content and a cobalt coating layer. A lithium composite oxide having a high nickel content may mean, in an embodiment, a lithium composite oxide having a nickel content of equal to or greater than about 80 mol %, or equal to or greater than about 88 mol % among metals excluding lithium. That is, x1 or x2 is equal to or greater than 0.8, or equal to or greater than 0.88 among the lithium composite oxides described above.

In an embodiment, the method for producing a positive electrode active material may include the method for producing a positive electrode active material, described with reference to FIG. 7. In an embodiment, the method for producing a positive electrode active material may include: synthesizing particles including a lithium composite oxide having a high nickel content; combining the particles with a first washing fluid; filtering the mixture; and heat-treating a solid mixture in the filtered mixture.

In an embodiment, the synthesizing particles including a lithium composite oxide having a high nickel content (S100) may include synthesizing the first particles PTC1 or the second particles PTC2. In an embodiment, the particles may include lithium byproducts remaining on the surface.

A first washing fluid WF1 may be added to the particles and be combined (S410). The first washing fluid WF1 may include the coating raw material, a precipitant (or a pH adjuster), and a solvent. The coating raw material may be a cobalt compound. In an embodiment, the cobalt compound may include cobalt sulfate, but is not particularly limited thereto. The precipitant (or pH adjuster) may include sodium hydroxide (NaOH) or the like. The solvent may include distilled water, an alkaline solution, or the like.

In this step, residual lithium byproducts on the surface of the particles may be removed.

In addition, in this step, a coating layer may be formed on the surface of the particles. Lithium byproducts may also be produced in this coating step. The lithium byproducts may be lithium byproducts remaining on the surfaces of the particles and/or the coating layer. The lithium byproducts may also be removed in this step.

This step may additionally include adding water to remove the residual lithium byproducts.

The mixture produced in this step may include a solid mixture and a liquid mixture. The liquid mixture may additionally contain sodium hydroxide as well as distilled water, an alkaline solution, or the like.

The mixture may be filtered (S430). Before heat-treating the particles, the liquid mixture may be removed in this step, and only a solid mixture may be separated. The liquid mixture may be referred to as a second washing fluid.

The separated solid mixture may be heat treated (S450), e.g., surface treatment. The mixture may be added to a furnace FRC and a third calcining process may be performed at a third temperature. In an embodiment, the third temperature may be about 500° C. to about 800° C. In an embodiment, the third temperature may be about 700° C. to about 800° C. The third calcining process may be performed in an oxidizing atmosphere such as air and oxygen. The heat treatment time of the third calcining process may be about 10 hours to about 30 hours. Thus, the positive electrode active material CAM described with reference to FIG. 6 may be produced.

The washing fluid may include the second washing fluid discharged in the filtering step (S430) of the mixture. The washing fluid may refer to the recovered second washing fluid.

The washing fluid may include lithium (Li) in a relatively high concentration. In an embodiment, the concentration of lithium (Li) in the washing fluid may have a concentration of equal to or greater than about 3500 ppm. In an embodimente, the concentration of lithium (Li) in the washing fluid may be about 3500 ppm to about 10000 ppm, or about 3500 ppm to about 5000 ppm.

The washing fluid may not include impurities. Alternatively, the washing fluid may include a trace amount of impurities. In an embodiment, the impurities may include sodium (Na), potassium (K), magnesium (Mg), calcium (Ca), chlorine (Cl), sulfate (SO₄), or the like. In an embodiment, the concentration of impurities in the washing fluid may be about 30,000 ppm or less. In an embodiment, the concentration of impurities in the washing fluid may be about 20 ppm to about 30,000 ppm. In an embodiment, the concentration of sulfate (SO₄) in the washing fluid may be equal to or less than about 30,000 ppm, or equal to or less than about 10 ppm to about 30,000 ppm, respectively.

In an embodiment, the components and contents of the washing fluid may be confirmed through an inductively coupled plasma (ICP) analysis method.

Referring to FIG. 12, the washing fluid according to a comparative embodiment of the present invention may refer to the second washing fluid including a third washing fluid discharged after conducting wastewater treatment process. The washing may refer to the recovered third washing fluid.

The wastewater treatment process may be performed through a wastewater treatment device. For example, the wastewater treatment device may include a filtrate tank, an immersion bath, a sedimentation bath, a filter part, a sludge discharge part or the like. Other types of domestic wastewater or the like may be introduced into the filtrate tank. The second washing fluid may be discharged through the wastewater treatment device described above as the third washing fluid.

The washing fluid may contain lithium (Li) in a low concentration. For example, the concentration of lithium (Li) in the washing fluid may be equal to or less than about 3500 ppm, or about 1000 ppm to about 3000 ppm. In addition, the washing fluid may contain excessive impurities. For example, the impurities may include sodium (Na), sulfate (SO₄) or the like. For example, the concentration of impurities in the washing fluid may be greater than about 30000 ppm. For example, the concentration of sodium (Na) in the washing fluid may equal to or greater than about 1000 ppm, or about 1000 ppm to about 90000 ppm. For example, the concentration of potassium (K) in the washing fluid may be equal to or greater than about 10,000 ppm, or from about 10,000 ppm to about 30,000 ppm. For example, the concentration of magnesium (Mg) in the washing fluid may be equal to or greater than about 5,000 ppm, or from about 5,000 ppm to about 20,000 ppm. For example, the concentration of chlorine (Cl) in the washing fluid may be equal to or greater than about 100,000 ppm, or from about 100,000 ppm to about 200,000 ppm. For example, the concentration of sulfate (SO₄) in the washing fluid may be greater than about 30,000 ppm, or from about 30,000 ppm to about 300,000 ppm.

The washing fluid according to embodiments of the present disclosure may have the effects below by omitting the wastewater treatment process with reference to FIG. 12. The washing fluid may contain lithium of a high concentration. In addition, the washing fluid may provide a high quality washing fluid where there are no impurities or a trace amount of impurities. Lithium may be recovered in a more economically efficient manner using the washing fluid according to embodiments of the present disclosure. The recovered lithium may be recycled in a rechargeable lithium battery.

### Recovery Device of Washing Fluid

FIG. 13 is a schematic diagram showing a recovery device of washing fluid according to embodiments of the present disclosure. The recovery device of washing fluid may include an additional tank part, a valve part, a line part, a pump part, or the like.

### Utilization of Washing Fluid

A lithium precursor may be recovered using the washing fluid. The recovered lithium precursor may be recycled as a raw material for producing a positive electrode active material.

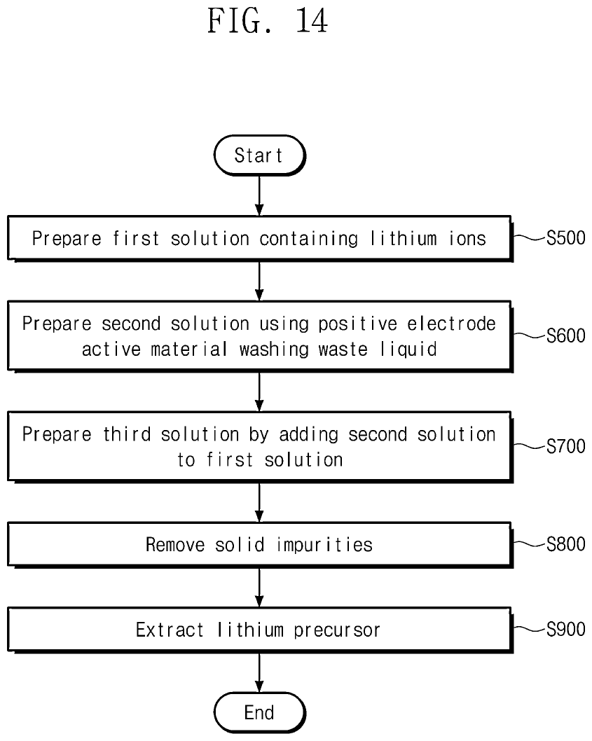

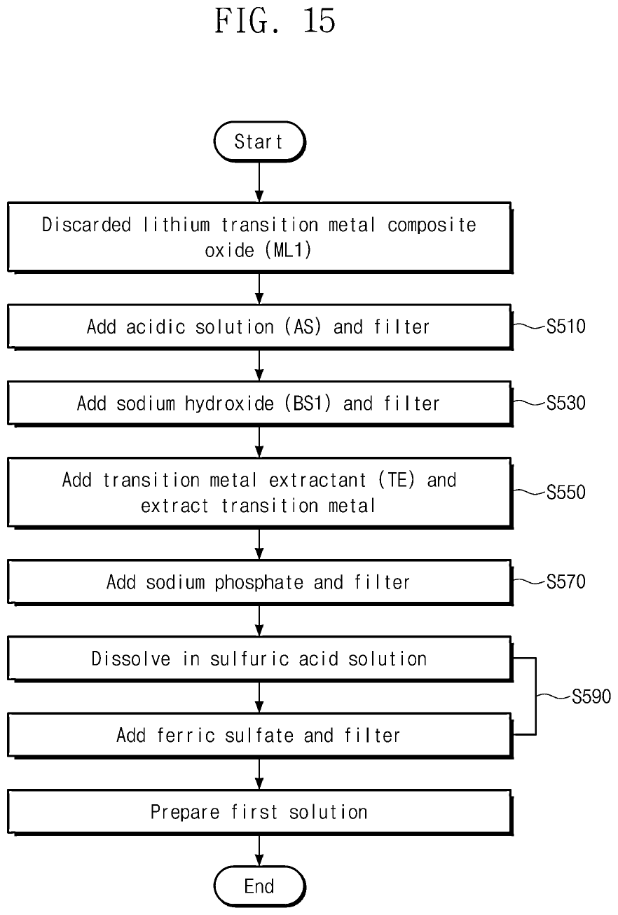

FIG. 14 is a flowchart showing a method for recovering a lithium precursor according to embodiments of the present disclosure. FIG. 15 is a flowchart showing a method for producing a first solution according to embodiments of the disclosure.

Referring to FIG. 14, a method for extracting a lithium precursor may include: preparing a first solution containing lithium ions (S500); preparing a second solution using waste liquid generated in a positive electrode active material washing process (S600); preparing a third solution by adding the second solution to the first solution (S700); removing precipitated solid impurities (S800); and extracting a lithium precursor (S900). A lithium precursor may be extracted from the waste liquid generated in the positive electrode active material washing process and a discarded lithium transition metal composite oxide. This way, the second solution may include the washing fluid.

Referring to FIG. 15, the method for preparing the first solution from a discarded lithium transition metal composite oxide (ML1) (S500) may include: adding the discarded lithium transition metal composite oxide (ML1) to an acidic solution (AS) then filtering to remove undissolved solids (S510); adding sodium hydroxide (NaOH) (BS1) then filtering to remove precipitates (S530); adding a transition metal extractant (TE) and extracting a transition metal (S550); adding sodium phosphate (Na₃PO₄) then filtering to obtain precipitated lithium phosphate (Li₃PO₄) (S570); dissolving the lithium phosphate in a sulfuric acid solution (S590); and adding ferric sulfate (Fe₂(SO₄)₃) then filtering to remove precipitated iron phosphate (FePO₄) (S590). The first solution including lithium ions may be prepared from the discarded lithium transition metal composite oxide (ML1).

The discarded lithium transition metal composite oxide (ML1) may be derived from a powder obtained by crushing a discarded rechargeable lithium battery or a waste generated in a rechargeable lithium battery manufacturing process. In an embodiment, the discarded lithium transition metal composite oxide (ML1) may include a compound of 3.

LiM1ₐM2_{b}M3_{c}M4_{d}O₂ [Chemical Formula 3]

where 0≤a≤1, 0≤b≤1, 0≤c≤1, 0≤d≤1, and a+b+c+d=1. Each of M1, M2, M3, and M4 in Chemical Formula 3 may be an element selected from Ni, Co, Al, Cu, Mn, Ti, Mo, Zn, Zr, Si, Ge, V, Cr, B, Mg, Na, Sr, Ag, Nb, Ga, Ca, or Ba.

The discarded lithium transition metal composite oxide (ML1) may include an NCA-based oxide including nickel (Ni), cobalt (Co), and aluminum (Al), or an NCM-based oxide including nickel (Ni), cobalt (Co), and manganese (Mn).

Among the materials that may be the raw materials of the discarded lithium transition metal composite oxide (ML1), the powder obtained by crushing the discarded rechargeable lithium battery may be obtained by crushing, heat-treating, and sorting the discarded rechargeable lithium battery. The powder obtained by crushing the discarded rechargeable lithium battery may include materials derived from a positive electrode, a negative electrode, a separator, and an electrolyte. In an embodiment, the material derived from the positive electrode may be aluminum (Al). The material derived from the negative electrode may be copper (Cu).

Among the materials that may be the raw materials of the discarded lithium transition metal composite oxide (ML1), the waste generated in the rechargeable lithium battery manufacturing process may be materials derived by crushing, heat-treating, and sorting a positive electrode active material and/or a positive electrode. Alternatively, the waste generated in the rechargeable lithium battery manufacturing process may be materials derived by solid-liquid separation and heat-treatment of a positive electrode slurry. The waste generated in the rechargeable lithium battery manufacturing process may include materials derived from a positive electrode active material, a positive electrode, and a positive electrode slurry. In an embodiment, the material derived from the positive electrode active material may be nickel (Ni).

The acidic solution (AS) may include at least one selected from sulfuric acid (H₂SO₄), hydrochloric acid (HCl), nitric acid (HNO₃), and phosphoric acid (H₃PO₄). If the acidic solution (AS) is added, hydrogen peroxide (H₂O₂) and/or sulfur dioxide (SO₂) may be added together to promote the dissolution of the transition metal.

The addition of sodium hydroxide (BS1) may be performed in a pH range where manganese (Mn), cobalt (Co), and nickel (Ni) are not easily precipitated. In an embodiment, if the amount of sodium hydroxide added is adjusted so that the pH is in a range of about 3 to about 4, manganese (Mn), cobalt (Co), and nickel (Ni) may be maintained in an ionic form, while iron (Fe) may be precipitated as Fe(OH)₃.

The precipitate formed after adding sodium hydroxide (BS1) may include elements other than manganese (Mn), cobalt (Co), and nickel (Ni) in the transition metal. In an embodiment, the precipitate may include iron (Fe), aluminum (Al), copper (Cu), zinc (Zn), magnesium (Mg), and/or calcium (Ca). The precipitate may include divalent and/or trivalent transition metals other than manganese (Mn), cobalt (Co), and nickel (Ni). In an embodiment, the precipitate may include aluminum hydroxide (Al(OH)₃) and/or copper hydroxide (Cu(OH)₂).

The filtering of the precipitate formed after adding sodium hydroxide (BS1) may be performed using a solid-liquid separation device such as a filter, a filter press, or a decanter (centrifuge).

Even after adding sodium hydroxide (BS1) and removing the precipitate through filtration, transition metal elements that have not yet been precipitated may still be included. In an embodiment, small amounts of aluminum (Al), copper (Cu), and/or iron (Fe) may still be included. The elements that have not yet been precipitated may be included in the first solution to be produced.

The transition metal extractant (TE) may include a phosphoric acid-based compound, a phosphonic acid-based compound, a phosphinic acid-based compound, and/or a carboxylic acid-based compound.

The process of extracting the transition metal by adding the transition metal extractant (TE) (S550) may be performed while sequentially increasing the pH. In an embodiment, while maintaining the pH in a range of about 3 to about 4, di-(2-ethylhexyl)phosphoric acid (D2EHPA) may be added to extract manganese (Mn). Afterwards, sodium hydroxide (NaOH) may be added to adjust the pH to a range of about 4 to about 5, and then bis(2,2,4-trimethylpentyl)phosphinic acid (Cyanex272) may be added to extract cobalt (Co). After that, sodium hydroxide (NaOH) may be added to adjust the pH to a range of about 5 to about 6, and then 2-ethylhexyl 2-ethylhexyphosphonic acid (PC88A) may be added to extract nickel (Ni).

Instead of the transition metal extractant (TE), a saponified transition metal extractant may be used. The mechanism of extracting the transition metal with the transition metal extractant (TE) may be that the hydrogen ion of the transition metal extractant (TE) is substituted with the transition metal ion, and the substituted transition metal ion and the anion of the transition metal extractant (TE) combine. This way, since the hydrogen ion separated from the transition metal extractant (TE) lowers the pH of the solution, the above-described transition metal extraction may not be easy while sequentially increasing the pH. Therefore, for supplementation, a saponified transition metal extractant in which the hydrogen ion of the transition metal extractant (TE) is substituted with a sodium ion may be used.

Even after the transition metal is extracted by adding the transition metal extractant (TE), transition metal elements that have not yet been precipitated may still be included. In an embodiment, small amounts of aluminum (Al), copper (Cu), and/or iron (Fe) may still be included. The elements that have not yet been precipitated may be included in the first solution to be prepared.

In the method for preparing the first solution, the steps of obtaining of lithium phosphate (Li₃PO₄) precipitated by adding sodium phosphate (Na₃PO₄) then filtering (S570), or the removing of the precipitated iron phosphate (FePO₄) by adding ferric sulfate (Fe₂(SO₄)₃) then filtering (S590) may be omitted.

Referring to FIG. 14, the second washing fluid recovered, i.e., the second solution, may include lithium hydroxide (LiOH) and/or lithium carbonate (Li₂CO₃) (S600). The second solution may further include sodium hydroxide (NaOH). The mass of lithium relative to the total mass of the second solution may be about 1,000 ppm to about 10,000 ppm.

The pH of the second solution may be may not be about 10 to about 15. This basic pH may be due to lithium hydroxide (LiOH) and/or lithium carbonate (Li₂CO₃) present in the second solution.

In the step of producing a positive electrode active material by calcining a mixture of a transition metal precursor and a lithium precursor, the lithium precursor may be a lithium precursor extracted according to the method of extracting a lithium precursor of the present disclosure. That is, the waste liquid, generated in the process of washing the positive electrode active material produced using the lithium precursor extracted, may be used again as a raw material for producing the second solution.

The first solution may be added to the second solution to produce a third solution (S700). The addition of the second solution (S700) may be for removing impurity ions other than lithium ions from the first solution. In addition, the addition of the second solution (S700) may be for recovering lithium ions contained in the second solution as a lithium precursor without providing a separate process.

The addition of the second solution (S700) may be performed so that the weight of lithium contained in the third solution (weight of contained lithium/weight of the third solution) relative to the total weight of the third solution does not exceed about 3,000 ppm. In an embodiment, the addition of the second solution (S700) may be the addition of the second solution while maintaining the pH of the third solution in a range of about 7 to about 11. By adding the second solution while satisfying the lithium content condition, an environment in which precipitation of lithium ions is difficult but precipitation of ions other than lithium is easy may be obtained. This way, by extracting impurity ions other than lithium ions while ensuring that the content of lithium ions is not reduced, high-purity lithium precursor may be obtained.

Precipitation of solid impurities may happen during adding the second solution to the first solution. Removal of precipitated solid impurities (S800) may be performed using a solid-liquid separation device such as a filter, a filter press, or a decanter (centrifuge).

The precipitated solid impurities may include those that are not precipitated in the step of adding sodium hydroxide (BS1) to the acidic solution in which the discarded lithium transition metal composite oxide (ML1) is dissolved then removing the precipitate through filtration (S530). The precipitated solid impurities may include elements other than manganese (Mn), cobalt (Co), and nickel (Ni) in the transition metal. In an embodiment, the solid impurities may include iron (Fe), aluminum (Al), copper (Cu), zinc (Zn), magnesium (Mg), and/or calcium (Ca).

The precipitated solid impurities may include those that are not extracted from extracting transition metals from the acidic solution (S550) in which the discarded lithium transition metal composite oxide (ML1) is dissolved and remaining. In an embodiment, the precipitated solid impurities may include manganese (Mn), cobalt (Co), and/or nickel (Ni).

The precipitated solid impurities may include divalent and/or trivalent transition metals. In an embodiment, the precipitated solid impurities may include Al(OH)₃ and/or Co(OH)₂. The precipitation may occur because the second solution is basic. Hydroxide ions (OH—) derived from the second solution may combine with divalent and/or trivalent transition metal ions to form the precipitated solid impurities. Unlike conventional methods for recovering general valuable metals, embodiments of the present disclosure may reduce the use of basic or alkaline solutions that contribute to environmental pollution, by adding the second solution instead of a general basic or alkaline solution.

A lithium precursor may be extracted (S900) from the third solution from which impurities have been removed. A basic or alkaline carbonate may be added into the third solution from which the impurities have been removed, and then a lithium precursor in the form of lithium carbonate (Li₂CO₃) may be recovered through solid-liquid separation. In an embodiment, the basic or alkaline carbonate may be sodium carbonate (Na₂CO₃). In an embodiment, the obtained lithium carbonate may be recycled and used as a raw material for a positive electrode active material containing nickel, in which the molar number of nickel is equal to or less than about 70%, about 60%, or about 50% compared to the molar number of metal elements other than lithium in the positive electrode active material.

An additional process may be performed to extract a lithium precursor in the form of lithium hydroxide (LiOH). The obtained lithium carbonate may be dispersed in an aqueous solution, and a hydroxide may be added into the aqueous solution. In an embodiment, calcium hydroxide (Ca(OH)₂) may be added as the hydroxide, calcium carbonate (CaCO₃) may be removed through solid-liquid separation, and a lithium precursor in the form of lithium hydroxide (LiOH) may be extracted through evaporation. The obtained lithium hydroxide may be used as a raw material for a high-nickel positive electrode active material in which the molar number of nickel is equal to or greater that about 50% of the molar number of metal elements excluding lithium in the positive electrode active material. In an embodiment, the high-nickel positive electrode active material may be LiNi_{0.8}Co_{0.15}Al_{0.05}O₂.

The lithium precursor obtained according to the present disclosure may be used as a raw material for producing a positive electrode active material. In an embodiment, the transition metal precursor used together as a raw material for producing a positive electrode active material may be a transition metal precursor of Chemical Formula 4.

M9ᵢM10ⱼM11ₖM12ₗO₂ [Chemical Formula 4]

where 0≤i≤1, 0≤j≤1, 0≤k≤1, 0≤l≤1, i+j+k+l=1, and each of M9, M10, M11, and M12 of Chemical Formula 4 is an element selected from Ni, Co, Al, Cu, Mn, Ti, Mo, Zn, Zr, Si, Ge, V, Cr, B, Mg, Na, Sr, Ag, Nb, Ga, Ca, or Ba.

The present disclosure will be described in more detail through Examples. However, Examples are only illustrations for describing the present disclosure, and the scope of the present disclosure is not limited to Examples.

### EXAMPLE

A washing fluid was prepared by recovering a second washing fluid. The second washing fluid was obtained by a method shown in the following.

Ni_{0.88}Co_{0.09}Al_{0.03}(OH)₂ and lithium hydroxide (LiOH) were mixed then calcined to prepare positive electrode active material particles. A first washing fluid was added to the positive electrode active material particles and combined. The first washing fluid contained cobalt sulfate (CoSO₄), sodium hydroxide (NaOH), and distilled water. As a result, the mixture contained a solid mixture and a liquid mixture.

The mixture was filtered to separate the liquid mixture, obtaining a second washing fluid. The second washing fluid was recovered to obtain the washing fluid of the present disclosure.

### COMPARATIVE EXAMPLE

A washing fluid was prepared by recovering a third washing fluid. The third washing fluid was discharged through a wastewater treatment process of the second washing fluid. The wastewater treatment process was carried out through a wastewater treatment device. The wastewater treatment device included a filtrate tank, an immersion bath, a sedimentation bath, a filter/filtering part, and a sludge treatment/discharge part.

### EXPERIMENTAL EXAMPLE: COMPONENT ANALYSIS

The components and contents of the washing fluids according to the Example and Comparative Example were analyzed by ICP. The results are shown in Table 1.

TABLE 1

| | | Comparative |
|---|---|---|
| Division | Example | Example |
| Lithium (Li) | 4450 | 2660 |
| content (ppm) | | |
| Sodium (Na) | 7483 or less | 3600 |
| content (ppm) | | |
| Sulfate (SO₄) | 30000 or less | 86053 |
| content (ppm) | | |

By using the method for recovering a washing fluid and the device for recovering the washing fluid, according to embodiments of the present disclosure, a relatively high lithium concentration washing fluid may be recovered. In addition, a washing fluid containing no impurities or a trace amount thereof may be recovered, resulting in a relatively high quality washing fluid.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A method for preparing a washing fluid, the method comprising:
preparing a positive electrode active material comprising a nickel-containing lithium composite oxide;
adding a first washing fluid to the positive electrode active material to form a mixture, wherein the first washing fluid comprises a coating raw material; and
recovering the washing fluid from the mixture,
wherein the recovered washing fluid has a lithium concentration equal to or greater than about 3500 ppm.

2. The method of claim 1, wherein the nickel-containing lithium composite oxide is represented by Chemical Formula 1:
Liₐ₁Niₓ₁M¹_{y1}M²_{z1}O_{2-b1}X_{b1} [Chemical Formula 1]
where 0.9≤a1≤1.8, 0.8≤x1≤1, 0≤y1≤0.2, 0≤z1≤0.2, 0.9≤x1+y1+z1≤1.1, and 0≤b1≤0.1,
M¹ and M² each independently comprises one or more elements selected from the group consisting of Al, B, Ba, Ca, Ce, Co, Cr, Cu, Fe, Mg, Mn, Mo, Nb, Si, Sr, Ti, V, W, and Zr, and
X comprises one or more elements selected from the group consisting of F, P and S.

3. The method of claim 1, wherein the coating raw material comprises a cobalt compound.

4. The method of claim 1, wherein the first washing fluid further comprises a precipitant and a solvent.

5. The method of claim 4, wherein the precipitant comprises sodium hydroxide.

6. The method of claim 4, wherein the solvent comprises distilled water or an alkaline solution.

7. The method of claim 1, wherein the lithium concentration is about 3500 ppm to about 10000 ppm.

8. The method of claim 1, wherein an impurity concentration of the recovered washing fluid is about 20 ppm to about 30000 ppm.

9. The method of claim 1, wherein the recovering step comprises filtering the mixture.

10. A device for recovering a washing fluid, the device comprising a tank part, a valve part, a line part, and a pump part, wherein the device is configured to recover the washing fluid from a mixture of a positive electrode active material and a first washing fluid.

11. The washing fluid, wherein the washing fluid has a lithium concentration of equal to or greater than about 3500 ppm.
